(19) United States
(12) Patent Application Publication
(10) Pub. No.: US 2025/0319990 A1
(43) Pub. Date: Oct. 16, 2025

(54) Light Emitting Diode Precision Approach Path Indicator

(71) Applicant: Hughey & Phillips, LLC, Urbana, OH (US)

(72) Inventors: Sergio Bastiani, Urbana, OH (US); Steven M. Schneider, Urbana, OH (US); Pablo Gonzalez, Weston, FL (US)

(21) Appl. No.: 18/930,716

(22) Filed: Oct. 29, 2024

Related U.S. Application Data
(60) Provisional application No. 63/617,817, filed on Jan. 5, 2024.

(51) Int. Cl. B64F 1/20; F21V 5/04; F21V 9/20; F21V 29/76; F21W 111/06; F21Y 113/10; F21Y 115/10

(52) U.S. Cl. CPC B64F 1/20; F21V 5/045; F21V 9/20; F21V 29/76; F21W 2111/06; F21Y 2113/10; F21Y 2115/10

(57) ABSTRACT

The present disclosure relates to precision approach path indicator (PAPI) systems. An example system includes a heatsink assembly and a plurality of optical channels. Each optical channel of the plurality of optical channels includes a light emitting diode (LED) source coupled to a first surface of the heatsink assembly. Each optical channel also includes a back collimating lens coupled to a second surface of the heatsink assembly. The LED source is configured to emit light through the back collimating lens to provide collimated light. Each optical channel also includes an optical filter disposed to interact with a first portion of the collimated light to form filtered light. Each optical channel also includes a front collimating lens configured to interact with the filtered light and a second portion of the collimated light to form output light.

### CROSS-REFERENCE TO RELATED APPLICATIONS

This application claims priority to U.S. Provisional Patent Application No. 63/617,817, filed Jan. 5, 2024, the contents of which are incorporated by reference

### BACKGROUND

Precision Approach Path Indicator (PAPI) systems are critical for ensuring the safe landing of aircraft. These systems provide visual feedback to pilots on whether their approach angle is too high, too low, or correct. Conventional PAPI systems consist of a series of lights typically located beside the runway. The lights change from red to white based on the angle of approach, guiding pilots to maintain an optimal glide path. Conventional PAPI systems have employed quartz halogen light sources to signal the correct approach path to pilots.

Current PAPI systems face several challenges:

Light Source Characteristics: quartz halogen lamps have been widely used in PAPI systems due to their initial cost-effectiveness and the ease of producing the required red and white light spectrum. However, they have limitations in terms of luminous efficiency and lifespan.

Energy Consumption and Heat Generation: quartz halogen bulbs consume more energy and generate significant heat compared to newer lighting technologies. This can lead to higher operational costs and the need for additional cooling systems to prevent overheating.

Maintenance Requirements: The relatively short lifespan of quartz halogen bulbs necessitates frequent replacements and maintenance checks, increasing the operational workload and potential downtime of conventional PAPI systems.

### SUMMARY

The present disclosure generally relates to systems for assisting pilots in maintaining the correct approach (in the vertical plane) to an airport or a runway.

In a first aspect, a system is provided. The system includes a heatsink assembly. The system also includes a plurality of optical channels. Each optical channel of the plurality of optical channels includes a light emitting diode (LED) source coupled to a first surface of the heatsink assembly. Each optical channel also includes a back collimating lens coupled to a second surface of the heatsink assembly. The LED source is configured to emit light through the back collimating lens to provide collimated light. Each optical channel also includes an optical filter disposed to interact with a first portion of the collimated light to form filtered light. Each optical channel also includes a front collimating lens configured to interact with the filtered light and a second portion of the collimated light to form output light.

Other aspects are possible and contemplated within the scope of the present disclosure.

### BRIEF DESCRIPTION OF THE FIGURES

FIG. 1 illustrates a system, according to an example embodiment.

FIG. 2 illustrates a landing scenario, according to an example embodiment.

FIG. 3 illustrates an output light configuration, according to an example embodiment.

FIG. 4 illustrates two conventional LED PAPI configurations.

FIG. 5 illustrates an oblique angle view of the system of FIG. 1, according to an example embodiment.

FIG. 6 illustrates an LED source of the system of FIG. 1, according to example embodiments.

FIG. 7 illustrates an oblique angle view of the system of FIG. 1 with an open housing, according to example embodiments.

FIG. 8 illustrates a side cutaway view of the system of FIG. 1, according to example embodiments.

FIG. 9 illustrates a heatsink assembly of the system of FIG. 1, according to example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### I. Overview

Systems and methods described herein relate to Precision Approach Path Indicator (PAPI) systems. PAPI systems are a visual aids that provide guidance information to help a pilot acquire and maintain the correct approach (in the vertical plane) to an airfield or runway. Such systems are especially useful for ensuring the safety of aircraft during the critical landing phase, especially in adverse weather conditions.

PAPI systems are utilized as a standard for Visual Glide Slope Indication (VGSI). Such systems are typically installed on the left side of the runway and consist of a series of light units or Light Head Assemblies (LHAs). These units are usually four in number, although other numbers of LHAs are possible and contemplated.

Each light unit is configured to emit red and white light, which may be projected at different angles. The system is set up so that the angle at which the color changes from red to white is aligned with the desired approach angle for the aircraft. When an aircraft is on the correct glide slope, the pilot will see two white lights and two red lights. This is often referred to as “two reds and two whites.” If the aircraft is too high, more white lights will be visible (e.g., three whites and one red), and if it is too low, more red lights will appear (e.g., three reds and one white).

The pilot adjusts the aircraft's approach path according to these visual cues. Achieving the right balance between red and white lights means the aircraft is on the correct glide slope for a safe landing. PAPI is particularly helpful during the final stages of approach, especially in visibility conditions where the runway is visible but the visual perspective might be misleading. The PAPI system is a crucial tool for pilots, especially during manual landings, helping to ensure a safe and accurate approach to the runway.

### II. Example Systems

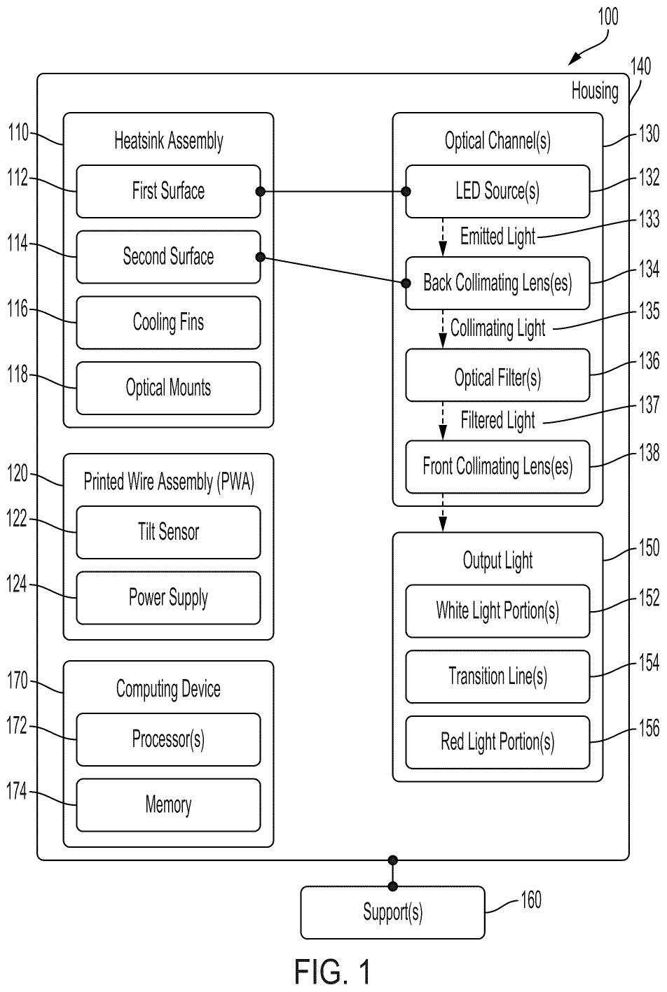

FIG. 1 illustrates a system 100, according to an example embodiment. The system 100 may be enclosed, at least in part, by a housing 140. The dimensions of the housing could be approximately 635 mm (H)×1,016 mm (L)×635 mm (D). However, it will be understood that system 100 could take on another size and could take other form factors.

The system 100 includes a heatsink assembly 110. The heatsink assembly 110 may be configured to manage and dissipate heat generated by electronic components, such as the LED sources 132 described below. The heatsink assembly 110 may beneficially improve reliability and efficient operation of system 100 by preventing overheating.

The system 100 also includes a plurality of optical channels 130. Each optical channel (e.g., first optical channel 130a, second optical channel 130b, and third optical channel 130c) of the plurality of optical channels 130 could include a light emitting diode (LED) source 132 coupled to a first surface 112 of the heatsink assembly 110.

Each optical channel 130 also includes a back collimating lens 134 coupled to a second surface 114 of the heatsink assembly 110. The LED source 132 is configured to emit light (e.g., emitted light 133) through the back collimating lens 134 to provide collimated light 135.

Each optical channel 130 additionally includes an optical filter 136 disposed to interact with a first portion (e.g., a top portion of the light beam) of the collimated light 135 to form filtered light 137.

Each optical channel 130 yet further includes a front collimating lens 138 configured to interact with the filtered light 137 and a second portion of the collimated light 135 to form output light 150.

As described, system 100 may include two different sets of collimating lenses. Collimating lenses are optical lenses designed to make light rays parallel. They are used in a variety of applications where precise beam shaping is required. It will be understood that various lens configurations can be used to create the desired collimated beam in this particular PAPI application. Specifically, the optical elements described herein could include a pair of double convex lenses and/or plano-convex lenses. In such scenarios, the focal length of the convex portion of the lens could be based on the distance of the respective lenses from the light source. In some embodiments, the focal length of the lens could be approximately 170 mm.

Additionally or alternatively, the collimated output beam could be formed using other optical lens configurations and lens types such as: achromatic doublets, aspheric lenses, Fresnel lenses, compound lens systems, parabolic reflectors, cylindrical lenses, and/or gradient index (GRIN) lenses.

In some examples, the heatsink assembly 110 includes a plurality of cooling fins 116 along the first surface 112. In various embodiments, the heatsink assembly 110 could utilize passive heat dissipation. The heatsink assembly 110 also includes a plurality of optical mounts 118. Each optical mount (e.g., optical mount 118a, 118b, 118c) corresponds to a respective optical channel (e.g., optical channel 130a, 130b, 130c) of the plurality of optical channels 130.

In various embodiments, at least one back collimating lens 134 includes a double convex lens. Additionally or alternatively, at least one back collimating lens 134 could include a plano convex lens or a Fresnel lens.

Similarly, at least one front collimating lens 138 could include a double convex lens, a plano convex lens, or a Fresnel lens. It will be understood that other types of optical lenses are contemplated and possible with the scope of the present disclosure.

In some examples, the optical filter 136 could include a red filter. In various examples, the optical filter 136 could provide a chromaticity where a Y Chromaticity Coordinate value does not exceed 0.320. It will be understood that other chromaticity and/or luminance values are possible and contemplated. The optical filter 136 could be designed to transmit red light while blocking other wavelengths. The composition and manufacturing of red optical filters can vary depending on the desired application and performance characteristics. In some embodiments, the optical filter 136 could be formed from colored glass using glass that has been doped with certain metal ions or pigments to give it a red tint. This glass selectively absorbs non-red wavelengths, allowing only red light to pass through. Examples of dopants for red filters include selenium and cadmium sulfide. Additionally or alternatively, optical filter 136 could be formed from a gelatin filters. These filters are made from gelatin or polyester with red dye embedded in them. Yet further, red optical filters can also be made from various polymers or plastics that have been dyed or pigmented to filter out all but red wavelengths. Optionally, optical filter 136 could include an interference filters, which may use multiple thin layers of different materials to create constructive and destructive interference for specific wavelengths of light. Furthermore, optical filter 136 could be formed from a coated filter or an acrylic filter.

In various embodiments, the optical filter 136 could include a flat optical filter. In some scenarios, the optical filter 136 corresponding to each optical channel 130 is arranged so as to cover different amounts of respective top portions of the collimated light 135.

In some examples, the LED source 132 could include a multifaceted reflector. In such scenarios, the LED source 132 could include a MR16 housing. In some examples, the LED source 132 could include a parabolic reflector, which may have a parabolic shape and may be designed to focus light into a spatially-directed beam. Optionally, the LED source 132 may incorporate an elliptical reflectors. In such scenarios, elliptical or oval-shaped reflectors may be configured to focus light to a specific focal point.

In various embodiments, the LED source 132 could be configured to provide white light having a color temperature in the range 3000K-5000K. It will be understood that other output light colors and color temperatures are possible and contemplated. In example embodiments, LED source 132 could be a visible light source. However, it will be understood that LED source 132 could emit infrared light and/or other wavelengths of light not natural perceivable by human senses.

In various examples, the output light 150 could include a transition line 154 defining a transition boundary between a white light portion 152 corresponding to the second portion of the collimated light 135 and a red light portion 156 corresponding to the filtered light 137.

In such scenarios, the transition line 154 may be no more than 3 arc minutes in width (e.g., vertical width or height).

Additionally or alternatively, the transition line 154 could be arranged based on a 3.00° nominal glide path of an aerial vehicle.

In various examples, the system 100 may additionally include a printed wire assembly (PWA) 120. In such scenarios, the PWA 120 could be configured to provide input power from at least one of: 120/240V or 6.6A constant current regulator (CCR). A CCR is an electronic device designed to maintain a consistent electrical current flow to a load, regardless of variations in input voltage or load resistance. This type of regulator is utilized in applications where a steady current is beneficial for optimal performance or safety. The CCR could include a feedback mechanism (like a current sensor), control circuitry, and a power handling element (like a transistor). The PWA 120 could include a printed circuit board (PCB) or another type of substrate having electrical circuit elements. The board then processes the input power to provide each LED lamp with 7 volts and 4 Amps, as well as monitor and do fault detection. It will be understood that the input power provided to each LED lamp could include a lower voltage and/or lower current, and therefore the input power could be provided by a lower wattage power source. The board connects to a smaller board hard-mounted to the body of the LHA. This board contains a solid-state MEMs accelerometer. The accelerometer monitors tilt in real time, and if any of the LHAs fall out of alignment, the PWA 120 will generate a fault that shuts down the entire PAPI system to prevent accidents.

In some embodiments, the system 100 includes a tilt sensor 122. In such scenarios, the tilt sensor 122 includes an accelerometer. As an example, the tilt sensor 122 and the accelerometer are configured to measure a tilt of the system 100 in real time. In some examples, the tilt sensor 122 could include a digital tilt switch. A digital tilt switch is an electronic device that detects changes in orientation, particularly tilt or inclination, relative to a fixed plane or axis (such as the ground plane). When a certain predetermined angle of tilt is exceeded, the switch activates, triggering a digital signal. Digital tilt switches may use various sensing mechanisms, such as mercury-filled bulbs, ball-in-cage mechanisms, or solid-state MEMS (Micro-Electro-Mechanical Systems) technology.

In various examples, the system 100 may include a computing device 170. As an example, the computing device 170 could include an electronic system configured to store, retrieve, and process data. In such scenarios, the computing device 170 could include one or more processors 172 (e.g., a central processing unit (CPU)) and a memory 174 configured to store program instructions. Memory 174 could include a random access memory (RAM). However other types of computer memory are possible and contemplated. The computing device 170 and the processor(s) 172 could be configured to execute the program instructions so as to carry out operations. In some examples, the operations could include receiving tilt data from the accelerometer and tilt sensor 122. The operations may additionally include determining whether an absolute value of the tilt data indicates an angle greater than a predetermined threshold angle. Yet further, the operations may include, in response to the tilt data being greater than the threshold angle, generating a fault indication. Additionally or alternatively, the operations may include, in response to the tilt data being greater than the threshold angle, disabling normal operation of the system 100 or switching to a fault mode of operation.

In various examples, the housing 140 could be coupled to the ground via one or more supports 160. In some embodiments, the supports 160 could include frangible mounts. Frangible mounts are used for objects near runways, like approach lights, signs, and navigational aids. If an aircraft veers off the runway or has an excursion, these mounts break away, reducing the risk of severe damage to the aircraft and potential injuries to passengers.

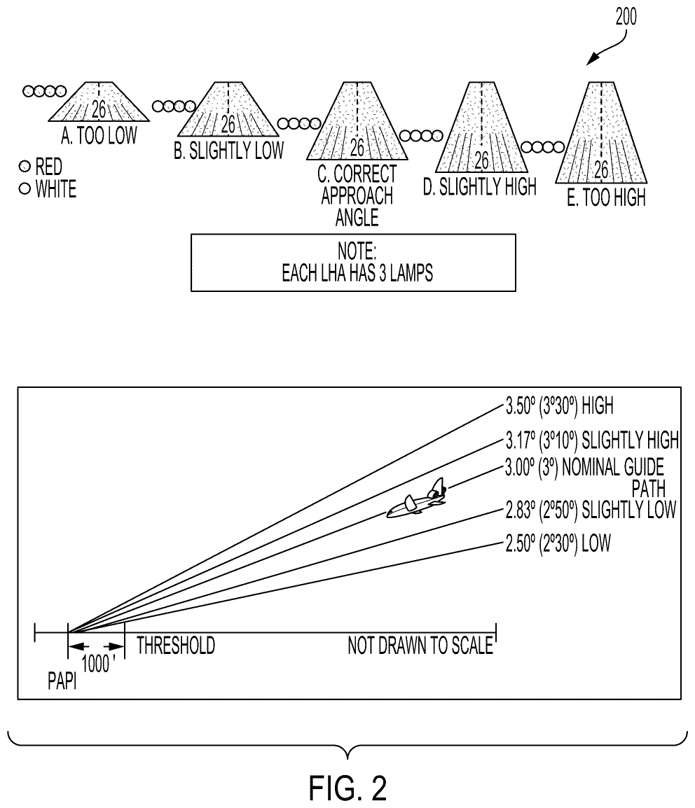

FIG. 2 illustrates a landing scenario 200, according to an example embodiment. As illustrated, the example system includes four (4) Light Head Assemblies (LHAs) installed perpendicular to a runway. Each of the LHA contains an optical system that provides a split color beam. The top half is White, the bottom half is Red. This split line is called the ‘Transition Line’ and is critical in its accuracy. When installed each of the four (4) LHAs are aligned at a specific vertical angle. This then creates a visual guide for approaching aircraft. The pilot sees a series of color combinations to determine his approach angle.

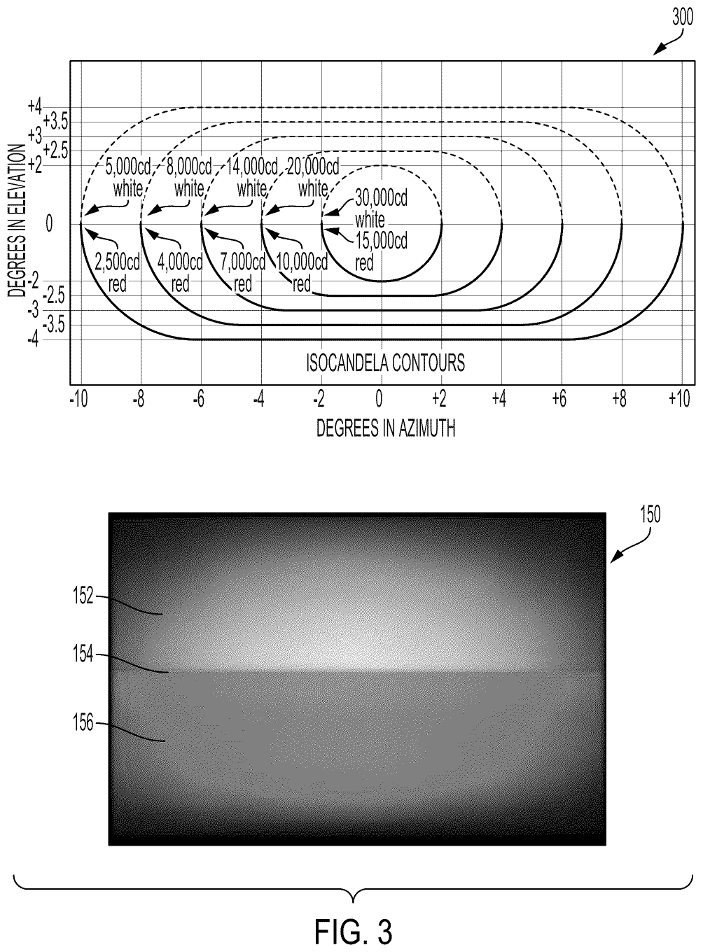

FIG. 3 illustrates an output light configuration 300, according to an example embodiment. Conventional PAPIs utilize Halogen MR16 style lamps. Each of the LHAs contained from two (2) to three (3) of these Halogen lamps (three (3) lamp system is the most common). Each lamp would have a red glass filter sitting in front of it, halfway up the lamp, which provided split color output light. The light was then fed onto a collimating lens (e.g., partially convex lens) which flipped the image placing the red color at the bottom and sharpening the transition line. In some conventional examples, the halogen lamps could be operated at 105W/6.6 A.

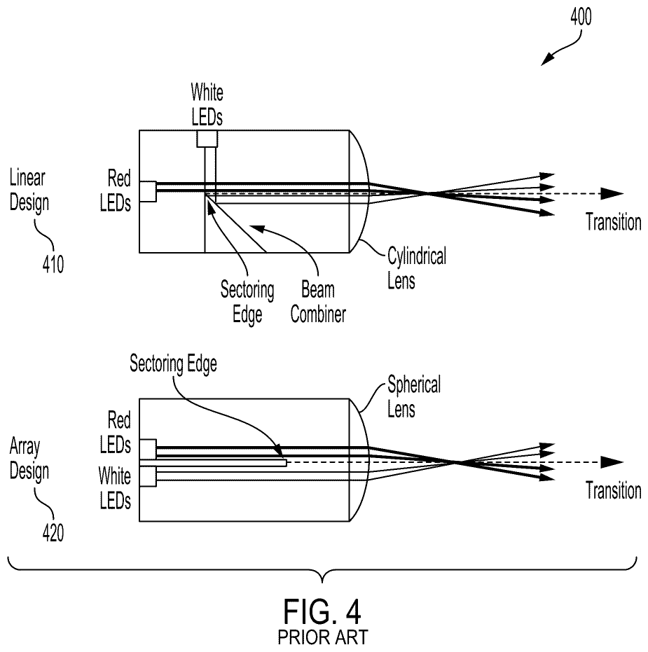

FIG. 4 illustrates two conventional light-emitting diode (LED) PAPI configurations 400 (e.g., linear design 410 and array design 420). LED PAPI systems operate in a similar manner as their Halogen counterparts. The lighting source is changed from a halogen lamp to an LED type source. Conventional LED PAPI systems utilize an array of individual LEDs in both White and Red color, and process these through a series of collimating lenses and/or reflective surfaces (e.g., mirrors). The white/red transition color comes from the LED source itself, while the sharp transition line is a product of the optical system. There are two main configurations for LED PAPIs in current use. The linear design 410 uses red LEDs mounted to the back face of the LHA, with the white LEDs mounted to the top. The white LEDs are emitted onto a 45-degree mirror which rotates its angle. Both light sources then meet a cylindrical half lens which cleans up the transition line. The array design 420 is an array of red LEDs atop, with white array below it. These LEDs are split by a thin piece of material to prevent color mixing, and the light is fed through a series of collimating lenses to focus the beam pattern.

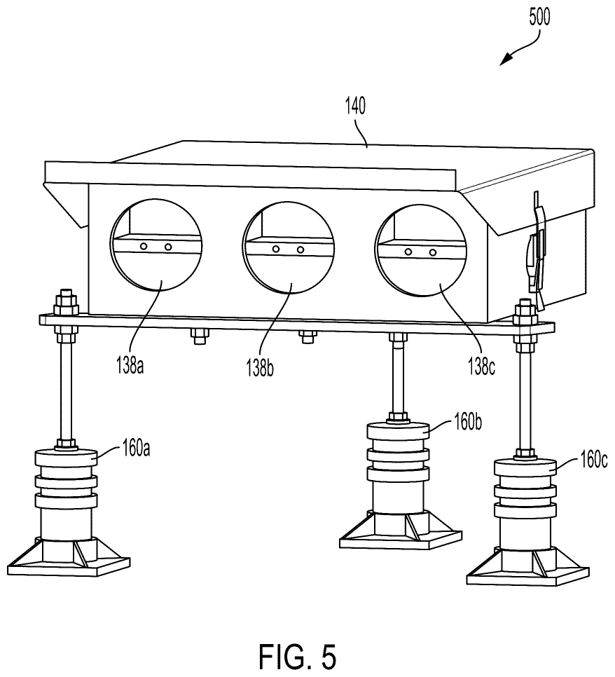

FIG. 5 illustrates an oblique angle view 500 of the system 100 of FIG. 1, according to an example embodiment.

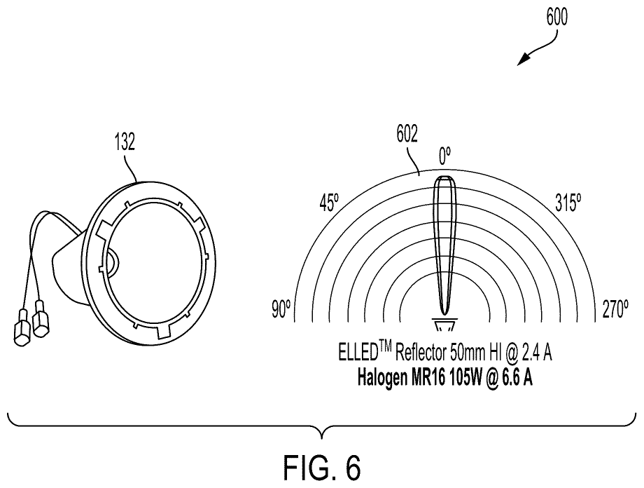

FIG. 6 illustrates an LED source 132 of the system 100 of FIG. 1, according to example embodiments. In examples, the LED source 132 could have an emission pattern 602, which may be similar or identical to that of a halogen light source. In some examples, the LED source 132 could include a 50 mm high intensity reflector and could be operated at 2.4 A. In some embodiments, the LED source 132 could be configured to emit the same lumen output as a 105W Halogen lamp with similar beam pattern. LED source 132 could include Part No. ELLEDREF506V3 from Ellego. However, other types of LED parts are possible and contemplated.

This LED source 132 feeds into a back collimating lens 134 which collimates and narrows the beam pattern. The emitted light is white light having a 3000-5000K color temperature. After interacting with the back collimating lens 134, a portion of the collimated light 135 then passes through an optical filter 136 to create the color split change and provide filtered light 137. In some embodiments, the back collimating lens 134 could include a diameter of 110 mm and could have a focal length of 170 mm. The optical filter 136 is darker red than that of halogen sources so as to convert the white light emitted from the LED source 132. In some embodiments, the optical filter 136 could be formed from borosilicate glass and have a transmittance of approximately 30%. In some embodiments, the Y value of the optical filter 136 could be 0.320. In such scenarios, the color could include “Aviation RED” per SAE-AS25050 and the optical filter 136 could include a filtered edge free of defects. The optical filter 136 provides a chromaticity value where Y does not exceed 0.320 to meet specifications. To accomplish this the red glass is darkened up slightly but reduced in thickness. The thickness reduction overcomes the loss in light output from darkening the filter.

The collimated light 135 and filtered light 137 then goes through the front collimating lens 138, which flips the image to allow for the red light portion 156 to be at the bottom and focuses the transition line 154 to be within 3 arc minutes.

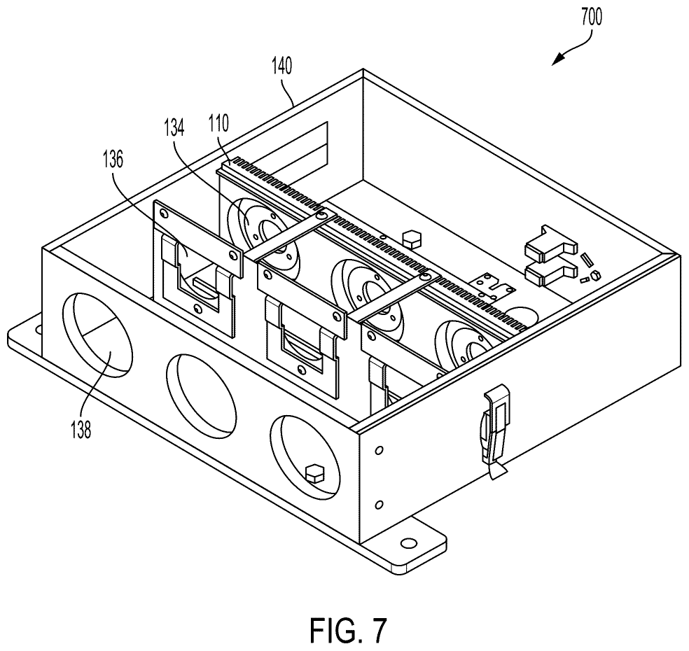

FIG. 7 illustrates an oblique angle view 700 of the system 100 of FIG. 1 with an open housing 140, according to example embodiments. As illustrated, system 100 could include three optical channels 130. However, more or fewer optical channels 130 are possible and contemplated.

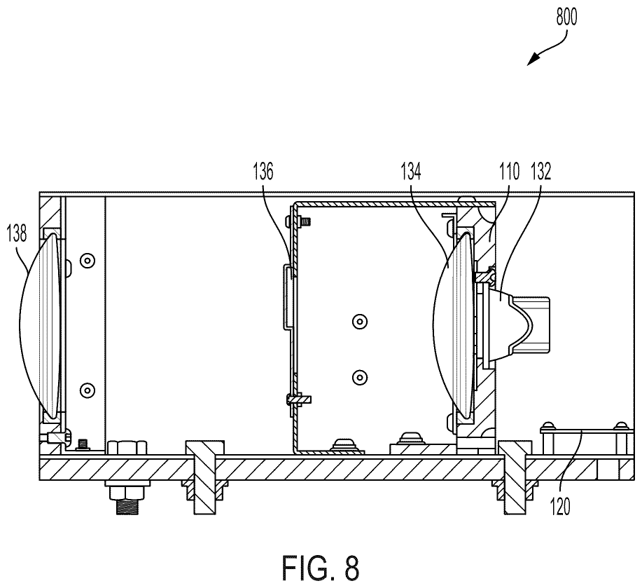

FIG. 8 illustrates a side cutaway view 800 of the system 100 of FIG. 1, according to example embodiments.

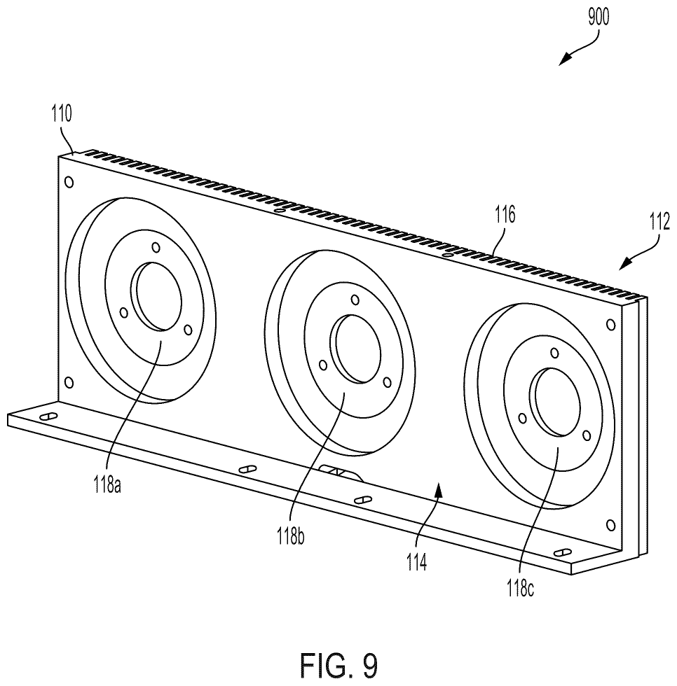

FIG. 9 illustrates a view 900 of the heatsink assembly 110 of the system 100 of FIG. 1, according to example embodiments. In some embodiments, the heatsink assembly 110 could include three optical mounts 118a, 118b, and 118c. However, more or fewer optical mounts 118 are possible and contemplated. In an example, heatsink assembly 110 could be formed from aluminum 6061-T6. It will be understood that other materials are possible and contemplated.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. A system, comprising:
a heatsink assembly; and
a plurality of optical channels, wherein each optical channel of the plurality of optical channels comprises:
a light emitting diode (LED) source coupled to a first surface of the heatsink assembly;
a back collimating lens coupled to a second surface of the heatsink assembly, wherein the LED source is configured to emit light through the back collimating lens to provide collimated light;
an optical filter disposed to interact with a first portion of the collimated light to form filtered light; and
a front collimating lens configured to interact with the filtered light and a second portion of the collimated light to form output light.

2. The system of claim 1, wherein the heatsink assembly comprises:
a plurality of cooling fins along the first surface; and
a plurality of optical mounts, each optical mount corresponding to respective optical channels of the plurality of optical channels.

3. The system of claim 1, wherein at least one back collimating lens comprises a double convex lens.

4. The system of claim 1, wherein at least one back collimating lens comprises a plano-convex lens or a Fresnel lens.

5. The system of claim 1, wherein at least one front collimating lens comprises a double convex lens.

6. The system of claim 1, wherein at least one front collimating lens comprises a plano-convex lens or a Fresnel lens.

7. The system of claim 1, wherein the optical filter comprises a red filter.

8. The system of claim 1, wherein the optical filter provides a chromaticity wherein a Y Chromaticity Coordinate value does not exceed 0.320.

9. The system of claim 1, wherein the optical filter comprises a flat optical filter.

10. The system of claim 1, wherein the optical filter corresponding to each optical channel is arranged so as to cover different amounts of respective top portions of the collimated light.

11. The system of claim 1, wherein the LED source comprises a multifaceted reflector.

12. The system of claim 1, wherein the LED source comprises a MR16 housing.

13. The system of claim 1, wherein the LED source is configured to provide 3000-5000K temperature.

14. The system of claim 1, wherein the output light comprises a transition line defining a transition between white light corresponding to the second portion of the collimated light and red light corresponding to the filtered light.

15. The system of claim 14, wherein the transition line is no more than 3 arc minutes in width.

16. The system of claim 14, wherein the transition line is arranged based on a 3.00° nominal glide path of an aerial vehicle.

17. The system of claim 1, further comprising:
a printed wire assembly (PWA), wherein the PWA is configured to provide input power from at least one of: 120/240V or 6.6A constant current regulator (CCR).

18. The system of claim 1, further comprising a tilt sensor, wherein the tilt sensor comprises an accelerometer, wherein the accelerometer is configured to measure a tilt of the system in real time.

19. The system of claim 18, further comprising a computing device, wherein the computing device is configured to execute program instructions so as to carry out operations, the operations comprising:
receiving tilt data from the accelerometer;
determining whether the tilt data indicates an angle greater than a threshold angle; and
in response to the tilt data being greater than the threshold angle, generating a fault indication.

20. The system of claim 19, wherein the operations further comprise:
in response to the tilt data being greater than the threshold angle, disabling normal operation of the system.
